(19) United States
(12) Patent Application Publication
(10) Pub. No.: US 2016/0053121 A1
(43) Pub. Date: Feb. 25, 2016

(54) HIGH-POROSITY FACING PAPER FOR PLASTERBOARDS

(71) Applicant: SINIAT INTERNATIONAL SAS, Avignon (FR)

(72) Inventors: Göran HEDMAN, Smedjebacken (SE); Jean-Michel FAURE, Oullins (FR)

(73) Assignee: SINIAT INTERNATIONAL SAS, Avignon (FR)

(21) Appl. No.: 14/781,302

(22) PCT Filed: Mar. 23, 2014
(86) PCT No.: PCT/EP2014/055778

§ 371 Date: Sep. 29, 2015

(30) Foreign Application Priority Data
Mar. 29, 2013 (FR) 1352946

(51) Int. Cl. C09D 1/00; C04B 7/04; B28B 1/30; D21H 19/38

(52) U.S. Cl. CPC C09D 1/00; D21H 19/385; C04B 7/04; B28B 1/30

(57) ABSTRACT

The invention relates to a plasterboard comprising a layer of plaster and at least one facing arranged on the latter, the facing being coated with a coating slip comprising a microporous material, said microporous material comprising agglomerates of precipitated silica. The invention also relates to a coating slip, a facing, and methods of manufacture for supplying said plasterboard.

### FIELD OF THE INVENTION

The present invention relates to facing papers for plasterboards having a high porosity, as well as the plasterboards comprising these facing papers and the coating slip for manufacturing these facing papers.

### TECHNICAL BACKGROUND

Plaster boards or panels are well known and are made conventionally from a body or core of gypsum-based plaster which is deposited, generally by casting, between two supports of paperboard providing both the mechanical support or reinforcement of the plaster and its external facing on its outer faces.

The manufacture of plaster panels of this type is described in document EP 0521804. It is also known, from the mentioned document, that depositing a coating slip on the external face of the facing paper with the objective of providing a good aesthetic appearance of the outer layer of said facing paper, preventing its yellowing and providing it with good uniformity of white colour is possible without having a negative influence on manufacture of said paper, on its durability over time and on its qualities of resistance, in particular of the mechanical strength.

Document WO 2006/010853 proposes an improved coating slip, containing plastic pigments as whitening agent. This coating slip makes it possible to obtain a particularly uniform visual appearance of the plasterboard.

However, it was found that the facing papers used in the prior art, in particular those having a satisfactory visual appearance, also have a reduced porosity. This leads to a relatively long drying time of the plasterboards.

It is therefore, desirable to develop facings for plasterboards having high porosity, yet also having satisfactory properties, in particular in terms of visual appearance.

### SUMMARY OF THE INVENTION

The invention relates firstly to a plasterboard comprising a layer of plaster and at least one facing arranged on the latter, the facing being coated with a coating slip comprising a microporous material, said microporous material comprising agglomerates of precipitated silica.

According to one embodiment, the microporous material is present in an amount in the range from 0.1 to 10% in the coating slip, preferably in the range from 0.5 to 5%, and more preferably in the range from 2 to 4% of dry matter.

According to one embodiment, the coating slip is present on the facing in an amount of between 2 to 50 g/m², preferably of between 5 to 35 g/m², more preferably of between 10 to 20 g/m² of dry matter.

According to one embodiment, the silica agglomerates have a size Dv50 of between 0.5 to 500 μm, preferably of between 5 to 200 μm, and more preferably of between 10 to 200 μm.

According to one embodiment, the agglomerates of precipitated silica correspond to the formula MeOₓ.mSiO₂,

Wherein,

Me represents at least two metals selected from Ca, Mg, Cu, Zn, Mn, Cd, Pb, Ni, Fe, Cr, Ag, Al, Ti, V, Co, Mo, Sn, Sb, Sr, Ba and/or W;

x represents the molar ratio of oxygen to metallic constituents; and

m represents the molar ratio of SiO₂ relative to the metallic constituents, and

wherein Me preferably represents Mg and Ca.

According to one embodiment, the molar ratio m is in the range from 1 to 4, preferably in the range from 2 to 3.5, more preferably in the range from 2.5 to 3.

According to one embodiment, the microporous material can be obtained by a method of manufacture comprising the following steps:
preparing a solution of at least two metal salts, in which the metal ions are divalent or polyvalent;
preparing a solution of alkali metal silicate;
mixing these solutions to form a coagulant;
rinsing and recovery of the coagulant;
optionally, adding impregnating agents to the coagulant.

According to one embodiment, in the method of manufacture:
the solution of alkali metal silicate has a silicate/alkali metal molar ratio in the range from 1 to 4, preferably in the range from 2 to 3.7, more preferably in the range from 3 to 3.7 and even more preferably of about 3.35;
the alkali metal is selected from K, Na or Li, preferably selected from Na or K and more preferably is Na; and/or
the metal salts are selected from the salts of Ca, Mg, Cu, Zn, Mn, Cd, Pb, Ni, Fe, Cr, Ag, Al, Ti, V, Co, Mo, Sn, Sb, Sr, Ba and/or W, preferably are selected from the salts of Ca and/or Mg; and/or
the metal salts are selected from chlorides, acetates or nitrates, preferably selected from magnesium chloride and/or calcium chloride; and/or
the solutions of metal salts have a concentration greater than or equal to 0.5 M, preferably greater than or equal to 1 M, more preferably greater than or equal to 1.5 M, and a concentration less than or equal to the saturation concentration; and/or
the solution of alkali metal silicate has a concentration of SiO₂ greater than or equal to 0.5 M, preferably greater than or equal to 1 M, more preferably greater than or equal to 1.4 M, even more preferably greater than or equal to 1.5 M, and preferably less than or equal to 4 M; and/or
the coagulant at the end of the rinsing and recovery step is adjusted to a dry matter content greater than or equal to 15%, preferably by filtration; and/or
the rinsing of the coagulant comprises the removal of free anions present in the coagulant; and/or
the impregnating agents are selected from KMnO₄, C₂H₂O₄, C₆H₈O₇, Na₂S₂O₃, NaClO, KOH, NaOH, KI, NaI, K₂CO₃, Na₂CO₃, NaHCO₃, KHCO₃, preferably KOH and/or KMnO₄; and/or
the impregnating agents are added to the coagulant in the form of crystalline powder, which is dissolved in the aqueous phase of the coagulant with stirring; and/or
the impregnating agents are present in the microporous material in an amount in the range from 0 to 20%, preferably in the range from 5 to 20% and more preferably in the range from 10 to 20%.

According to one embodiment, the coating slip further comprises plastic pigments, preferably in an amount in the range from 0.1 to 10%, more preferably in the range from 0.5 to 3% of dry matter.

According to one embodiment, the coating slip further comprises:
fillers, preferably comprising calcium carbonate and/or potassium carbonate, preferably in an amount in the range from 5 to 50%, more especially preferably in the range from 25 to 35% of dry matter; and/or
a binder, preferably comprising a synthetic latex and preferably a styrene-butadiene resin, preferably in an amount in the range from 2 to 20%, more preferably of in the range from 4 to 10% of dry matter; and/or
titanium dioxide, preferably in an amount in the range from 1 to 20%, more preferably in the range from 5 to 10% of dry matter; and/or
one or more additives selected from dispersants, antifoaming agents, thickeners, biocides and/or colorants.

The invention also relates to a facing for plasterboard, the facing being coated with a coating slip comprising a microporous material, said microporous material comprising agglomerates of precipitated silica.

According to one embodiment, the coating slip is as described above.

The invention also relates to a composition for coating plasterboard, comprising a microporous material, said microporous material comprising agglomerates of precipitated silica.

According to one embodiment, this composition is a coating slip for facing plasterboard, said coating slip preferably being as described above.

According to an alternative embodiment, this composition is a paint for a wall made from plasterboard, in which preferably the microporous material is as described above.

According to one embodiment, this composition comprises:
microporous material in an amount in a range from 0.2 to 15%, preferably in a range from 1.5 to 10%, and more preferably in a range from 5 to 7% of dry matter; and/or
fillers, preferably comprising calcium carbonate and/or potassium carbonate and/or titanium dioxide, preferably in an amount in a range from 20 to 95%, more preferably in a range from 70 to 90% of dry matter; and/or
a binder, preferably comprising an acrylic resin, preferably in an amount in a range from 2 to 20%, more preferably in a range from 10 to 14% of dry matter; and/or
one or more additives selected from dispersants, antifoaming agents, thickeners, biocides and/or colorants.

The invention also relates to a method of manufacturing a facing as described above, comprising providing a facing paper, and applying the aforementioned coating slip on the facing paper.

The invention also relates to a method of manufacturing a plasterboard as described above, comprising:
mixing a plaster paste for providing the layer of plaster of the plasterboard;
providing a first facing and a second facing;
applying the layer of plaster on the first facing;
applying the second facing on the applied layer of plaster;
forming, drying and optionally cutting into boards.

According to one embodiment:
the first facing and/or the second facing is/are as described above; or
providing the first facing and/or the second facing comprises manufacturing the facing by the method mentioned above; or
the aforementioned coating slip is applied on the first facing and/or second facing after applying the layer of plaster and before drying.

The invention also relates to the use of a microporous material comprising agglomerates of precipitated silica, in order to increase the porosity of a plasterboard surface.

According to one embodiment, the microporous material is as described above.

According to one embodiment, this use is for the purpose of increasing the porosity of a plasterboard facing.

According to one embodiment, the microporous material is incorporated in the form of a gel in a coating slip for plasterboard facing or in a paint for a wall made from plasterboards, said gel preferably having a water content in a range from 40 to 95%, more preferably in a range from 60 to 92%, and even more preferably in a range from 80 to 90%.

The present invention is able to overcome the drawbacks of the prior art. More particularly it provides plasterboards having both a satisfactory visual appearance, namely without yellowing, and with good uniformity of white colour, and an improved porosity.

This is achieved by incorporating a microporous material comprising agglomerates of precipitated silica in the coating slip. It was found that this incorporation leads to the appearance of microcracks on the surface of the facing, increasing the Gurley porosity of the facing; and that moreover the other properties of the coating slip and of the coated facing (viscosity, gloss, whiteness etc.) are essentially unchanged, or possibly are altered minimally, and any such change can easily be compensated by adjusting the other components of the coating slip.

In general, the invention proves to be useful in all applications of coating of surfaces, in which water or water vapour must be able to pass through or be transported through the coating.

Moreover, the capacity of the microporous material for creating microcracks can also be utilized in the formulation of a paint intended to be applied on any substrate, and in particular on plasterboards whether individual or assembled in the form of a wall (wall, ceiling, partition, false ceiling, etc.). Such a paint can notably allow improved properties of sound absorption to be obtained. The paint can be applied directly on the facing of the plasterboards, or on a coating layer deposited on the latter.

### DESCRIPTION OF EMBODIMENTS OF THE INVENTION

A more detailed, non-limiting description of the invention is given below.

Unless stated otherwise, any proportions stated are proportions by weight.

The microporous material used in the context of the invention is described in detail in document WO 2006/071183. It is a material of the aerogel type.

The microporous material can be manufactured by a reaction of precipitation where a solution of alkali metal silicate is brought in contact with a saline solution containing divalent or polyvalent metal cations.

On mixing a soluble silicate with salt solutions containing metals other than those of the alkali metal group, insoluble amorphous metal silicates are obtained by precipitation. This method is called the coagulation process; the particles form relatively compact aggregates, in which the silica is more concentrated than in the original solution, so that the coagulant sediments in the form of a relatively dense precipitate.

The precipitated coagulant thus obtained is then rinsed with water until the residual reaction products and excess reactants are removed. Some of the water of the suspension is then removed for example by vacuum filtration or by centrifugation, until a relatively viscous paste is obtained, for example with about 15% dry matter.

The material can be impregnated with impregnating agents, for example by adding these agents at a suitable concentration in a final step of rinsing of the coagulant. Alternatively, these agents can be added to the paste after rinsing and removal of some of the water from the suspension.

The document WO 2006/071183 describes forming of the material into granules or other forms, and drying of the material to a dry matter content above 75%, or 90%, or 95%, or 97%. Drying is typically carried out at a temperature from 50 to 250° C., for example of 105° C.

Although it is possible to use the microporous material in this dried form, it is preferred in the context of the invention to omit drying, or else carry out more limited drying, and consequently use the material in the form of a gel or a paste for making the coating slips. The water content is thus advantageously in a range from 40 to 95%, more preferably in a range from 60 to 92%, and even more preferably in a range from 80 to 90%, at the time of use of the material.

The alkali metal silicates usable for manufacture of the material can be based on sodium or potassium, or even lithium. It is also possible to use a silicate composed of SiO₂ and Na₂O. The commercially available alkali metal silicates generally have molar ratios of silicate fraction to alkali fraction in a range from 1.6 to 3.9.

To obtain the coagulation reaction, the dilute solution of alkali metal silicate, typically at a concentration of 1.5 M with respect to SiO₂, is mixed with a concentrated or even saturated solution of salts containing magnesium and/or calcium, for example MgCl₂ and CaCl₂. However, any readily soluble salt such as a nitrate or an acetate can also be used. Moreover, other divalent or polyvalent cations can be used instead of Mg and Ca, such as Cu, Zn, Mn, Cd, Pb, Ni, Fe, Cr, Ag, Al, Ti, V, Co, Mo, Sn, Sb, Sr, Ba and/or W.

When the dilute solution of sodium silicate is mixed with magnesium chloride and/or calcium chloride with vigorous stirring, the mixture coagulates immediately, according to the following reaction:

Na₂O.nSiO₂ (l)+1/2Mg²⁺+1/2Ca²⁺→(Mg, Ca)O.nSiO₂ (s)+2Na⁺

where
n represents the molar ratio of SiO₂ to Na₂O. The amount of Mg and/or Ca in the final product depends on the molar ratio n. The lower this molar ratio, the higher the content of Mg and/or Ca in the coagulant relative to the silicate. Thus, to maximize the content of Mg and/or Ca in the product, an alkali metal silicate must be used having a molar ratio n that is as low as possible.

The silica particles enriched with Mg and/or Ca are coagulated in the form of aggregates dispersed in the aqueous medium, then they are recovered on a filter, rinsed, and optionally formed and dried.

Thus, the microporous material used in the invention has the formula MeOₓ.mSiO₂, in which

Me represents at least two metals selected from Ca, Mg, Cu, Zn, Mn, Cd, Pb, Ni, Fe, Cr, Ag, Al, Ti, V, Co, Mo, Sn, Sb, Sr, Ba and/or W;

x represents the molar ratio of oxygen to the metallic constituents; and

m represents the molar ratio of SiO₂ to the metallic constituents.

The silica agglomerates preferably have a size Dv50 in a range from 0.5 to 500 μm, preferably in a range from 5 to 200 μm, and more preferably in a range from 10 to 200 μm.

Preferably, the molar ratio m=Si/Me is in a range from 1 to 4, preferably in a range from 2 to 3.5, more preferably in a range from 2.5 to 3.

The impregnating agents are for example impregnated in an amount in a range from 5 to 20%, and preferably in a range from 10 to 20%.

The material according to the invention preferably has a porosity in a range from 0.5 to 1.2 cm³/g, and/or a BET surface area in a range from 300 to 800 m²/g.

The material according to the invention is incorporated in a coating slip for plasterboard facing, preferably in the form of the gel described above, in an amount in a range from 1 to 30%, preferably in a range from 2 to 20%, and more preferably in a range from 5 to 15% of dry matter.

The coating slip is preferably based on water. It preferably comprises advantageously plastic pigments as whitening agent, as is described in detail in document WO 2006/010853.

The plastic pigments, also called organic pigments in contrast to the inorganic pigments such as clay, talc or calcium carbonate for example, are synthetic polymer latices whose glass transition temperature is high enough to give these latices a non-film-forming property or properties enabling the particles making up this type of latex to remain separate.

The plastic pigments or organic pigments usable in the coating slip according to the invention can be selected from the plastic pigments available on the market, and in particular from the plastic pigments with solid particles or with hollow particles. Preferably, the plastic pigments are formed from hollow particles, i.e. comprising a free internal space.

As a non-limiting example, the plastic pigments used in the slip can be plastic pigments sold under the reference Ropaque® by the company Dow.

In addition to the plastic pigments, the coating slip preferably also comprises a mineral filler. As mineral filler, it is possible to use calcium carbonate, or potassium carbonate, or any equivalent filler, for example calcium sulphate dihydrate. Combinations of these compounds can also be used.

The coating slip preferably also comprises a binder, in particular a synthetic binder, and preferably a synthetic latex. As an example, it is possible to use a styrene-butadiene or styrene acrylic binder, or several other synthetic polymer materials such as polyvinyl acetates and polymers based on acrylic monomers, as well as polymer materials of natural origin, such as, non-exhaustively, modified or unmodified amylaceous polymers, proteins of the casein type or a mixture of synthetic polymer materials with polymer materials of natural origin.

A relatively high content of binder improves the abrasion resistance of the coated paper, and therefore of the plasterboard.

In addition to the components stated above, the coating slip can optionally comprise additives or secondary compounds and preferably titanium dioxide (as additional filler), a pH regulator (for example sodium hydroxide), a thickener, an antifoaming agent, a biocide, a colorant and/or a dispersant.

According to one embodiment, the coating slip comprises an amount of water in a range from 10 to 50%, preferably in a range from 20 to 30%, and further comprises:
microporous material according to the invention in an amount in a range from 0.05 to 10%, preferably in a range from 2 to 4% of dry matter;
plastic pigments in an amount in a range from 0.1 to 10%, preferably in a range from 0.5 to 3% of dry matter;
binder in an amount in a range from 1 to 20%, preferably in a range from 4 to 10% of dry matter;
fillers of the calcium carbonate and/or potassium carbonate type in an amount in a range from 5 to 50%, preferably between 25 to 35% dry of matter;
titanium dioxide in an amount in a range from 1 to 20%, preferably in a range from 5 to 10% of dry matter;
thickener in an amount in a range from 0.01 to 5%, preferably in a range from 0.1 to 1% of dry matter.

The coating slip is applied on a facing, or facing paper, either before manufacture of the plasterboard, optionally with intermediate steps of drying, cutting, conditioning of the coated facing; or during manufacture of the plasterboard, after applying the plaster paste on the facing.

In general, the plasterboard comprises two facings, between which the plaster body or core is cast or applied or formed. The two facings can comprise the coating slip, on their faces opposite to the plaster core, or preferably just one of these facings (the one that is intended to be exposed to view) comprises this coating slip on its face opposite to the plaster core.

The facings comprises or consists of sheets of paper or of paperboard.

The boards can preferably be manufactured by pouring the plaster on one of the facing papers, then placing the second facing paper, then drying of the board leading to considerable evaporation of water and production of the definitive building board after hardening. Reference is made to document EP 0521804 for more details.

The facing paper used is preferably a multilayer paper that can for example be formed by a stack of two or more layers, and in particular of two to nine layers, without the number of layers being limiting.

Particularly advantageously, the facing paper is formed by a succession of two layers, it being understood that it can also be made using a stack of three or five layers.

The characteristics of the paper, given below but not in any way limiting, for example its weight (standard NF Q 03-019), or its thickness (standard NF Q 03-016), its properties of water absorption, that is its properties of absorption of water on the face in contact with the sheet of plaster or Cobb three minutes (standard NF Q 03-014), its permeability to air (Gurley porosity—standard NF ISO 5636-5), its breaking strength (standard NF Q 03-004), its inter-ply strength, its elongation under water measured at one minute at 23° C. in the transverse direction (standard NF Q 03-063), etc. are suitable for withstanding the presence and the evaporation of water as well as the various manufacturing operations.

As non-limiting examples, the paper basis weight can be from 100 to 250 g/m², and preferably from 160 to 200 g/m², and even more preferably from 180 to 200 g/m².

In general, production of a plasterboard at reduced cost, compared with the conventional boards, can be based on the use of a less expensive facing paper, which correlatively involves having recourse to fibres of less good quality leading finally to a paper generally of a darker colour and for example of the order of 50 to 70 ISO (ISO 2469/2470), and for example of the order of 60.

Advantageously, the top layer of the facing paper intended to form the exterior of the plasterboard, and which therefore constitutes the visible face of the board, is made starting from a mixture of bleached or semi-bleached recycled fibres such as white offcuts or out-of-date office papers. The references and nomenclatures of papers mentioned in document EP 0521804 are fully applicable here (group C and preferably C7 to C9 and C11, C12, C14 to C19).

The top layer can also be made from recycled unprinted office paper or from newspaper. For information, other fibres or pulps that can be used are bleached or semi-bleached virgin cellulose fibres such as chemical-mechanical fibres, thermo-mechanical fibres or thermo-mechanical chemical fibres.

The basis weight of the top layer can be for example in a range from 20 to 90 g/m², and preferably in a range from 30 to 50 g/m². The weight of the top layer of the facing paper plays an important role in obtaining the final whiteness of the paper and a person skilled in the art will adapt the weight of the top layer in relation to the weight and properties of the other layers, as well as in relation to the properties of the coating slip.

Non-exhaustively, the whiteness of the top layer can be of in a range from 65 to 68 ISO. The layer of the paper that is in contact with the plaster (gypsum) is advantageously made from old embossed cardboard, or else from recycled raw materials from domestic use and including for example packaging for liquids, or similar types of fibres, or a mixture of these fibres that can give these layers the necessary solidity and porosity.

The top face of the facing or top ply of the paper, which constitutes the visible face of the plasterboard, is intended to receive a coating slip to endow this surface with superior aesthetic qualities and preferably one or more qualities selected from:
a surface with a confirmed, uniform whiteness;
a surface with little or no yellowing during use, notably due to UV radiation;
a surface that does not require subsequent supply of a printing primer;
a surface that is easy to clean;
a surface that allows the placing and especially the deposition of painted paper without deterioration of the paper layer, and notably which allows the successive removal of several layers of paper without major deterioration;
a surface that does not need to be painted immediately after installation of the plaster board or panel.

The coating slip is able to meet the objectives stated above without altering the qualities and functions of the paper with respect to its role of reinforcement and removal of water during drying of the plaster.

The coating slip is applied on the facing in an amount of in a range from 2 to 50 g/m², preferably in a range from 5 to 35 g/m², more preferably in a range from 10 to 20 g/m² of dry matter.

The provision of coating slip depends on the initial degree of whiteness of the paper: the whiter the base paper, the more the provision of the coating slip can be reduced. The degree of whiteness of the coated paper, i.e. coated with the coating slip is advantageously ISO gloss index of 75 and 85 and preferably from 78 to 80.

The coating slip is applied by the usual techniques used in this field such as by air knife or by roller or by doctor blade or by spraying or some other technique, or else by a combination of several of these techniques that are well known by a person skilled in the art and referenced for example in document EP 0521804.

Preferably, the Gurley porosity of the facing paper is less than or equal to 280 s/mL air, and according to certain embodiments less than or equal to 270, or 260, or 250 or 240, or 230, or 220, or 210, or 200 or 190, or 180, or 170, or 160, or 150, or 140, or 130, or 120, or 110, or 100, in seconds per 100 mL of air. This porosity notably allows rapid and effective drying of the plasterboards during manufacture.

The plasterboards according to the invention are used conventionally as building materials and serve for forming partitions or ceilings, or else to form double walls in particular for insulation.

### EXAMPLES

### Example 1

### Laboratory Coating Tests

A coating slip is prepared from the following basic formulation:
water: 270 parts;
potassium carbonate (Hydrocarb® 90): 530 parts;
poly(sodium acrylate) (dispersant, Topsperse® GXN): 2.8 parts;
calcium carbonate (Durcal® 10): 25 parts;
titanium dioxide: 75 parts;
carboxymethylcellulose at 7% in water (thickener): 50 parts;
antifoaming agent (Etingal® S): 0.8 part;
plastic pigments (Ropaque® E): 40 parts;
styrene-butadiene copolymer (binder XZ 94362): 130 parts;
crosslinking agent (Ukacross® 87 A): 4.6 parts;
biocide (Intace® B7937): 3 parts;
yellow oxide (Hostatint®): 0.36 part.

In certain variants, the styrene-butadiene copolymer is replaced with an acrylic polymer or a vinyl acetate polymer at equivalent amount of dry matter.

Depending on the experiment, a variable amount of gel of microporous material according to the invention (gel comprising 15% dry matter), supplied by the company Svenska Aerogel AB, is added to this basic formulation. More precisely, 5, 10, 15, 20 or 25 parts of gel of microporous material are added to 100 parts of coating slip.

The coating slip is prepared using a Heidolph® RZR2021 disperser equipped with a dispersing disc with a diameter of 70 mm. Firstly, one third of the water, the calcium carbonate, titanium dioxide, antifoaming agent and dispersant are mixed for 15 minutes. Then the rest of the water is added, as well as the thickener, plastic pigment, binder and crosslinking agent. The mixture is stirred for 10 minutes. The biocide and the yellow colorant are added and the mixture is homogenized for 3 minutes. Finally the gel of microporous material is added and the mixture is stirred until the gel of microporous material has dispersed (from 3 to 5 minutes).

The coating slip is then applied manually on sheets of paperboard of A4 format using bar applicators. Thicknesses of 16 and 26 μm are used. The weight obtained is about 15 g/m². The sheets thus coated are left to dry in a stove at 105° C. for a few minutes. Next, the Gurley porosity of the sheets is tested according to standard NF ISO 5636-5. The results are presented in Table 1 below:

TABLE 1
measurements of Gurley porosity

| Dry matter | | | |
|---|---|---|---|
| content of | Coating slip | | |
| microporous | with styrene- | Coating slip | Coating slip |
| material in the | butadiene | with acrylic | with vinyl |
| coating slip | binder | binder | acetate binder |
| 0% | 90 | 265 | 460 |
| 5% | 76 | 162 | 301 |
| 10% | 74 | 126 | 199 |
| 15% | 70 | 103 | 137 |
| 20% | 64 | 84 | 85 |
| 25% | 59 | | |

Furthermore, the gloss at 85° is tested according to standard ISO 2813 for the sheets prepared with the coating slip comprising the styrene-butadiene binder. The results are presented in Table 2 below:

TABLE 2
measurements of gloss

| | Dry matter content of | |
|---|---|---|
| Content of gel of | microporous material in | |
| microporous material | the coating slip | Gloss (85°) |
| 0% | 0% | 18.3 |
| 5% | 0.75% | 17.5 |
| 10% | 1.5% | 14 |
| 15% | 2.25% | 12.4 |
| 20% | 3% | 8.6 |
| 25% | 3.75% | 8.3 |

It can therefore be seen that the invention allows significant improvement of the porosity to air of a facing paper, without degrading the gloss excessively. It should also be noted that the relative degradation of gloss observed can be compensated by adjusting the formulation of the coating slip (notably via the amounts of filler, of titanium dioxide, and of plastic pigment).

### Example 2

### Pilot Plant Coating Test

The coating slip from example 1, with styrene-butadiene binder, is used for making paper for plasterboards in a pilot plant.

Three coating slips were tested, the coating slip from example 1 without gel of microporous material, a coating slip in which 5 parts of gel of microporous material were dispersed and a coating slip in which 15 parts of gel of microporous material were dispersed.

In this example, the coating is applied by bath. The amount of coating slip applied is controlled by air knife. The paper is then dried in a hot air tunnel. The properties of the paper are summarized in Table 3 below:

TABLE 3
various measurements on coated paper

| | Coating slip | Coating slip | Coating slip |
|---|---|---|---|
| | without | with 0.75 wt % | with 2.25 wt % |
| | microporous | microporous | microporous |
| | material | material | material |
| Colorimetry L* | 90.04 | 90.33 | 90.22 |
| Colorimetry a* | −0.42 | −0.46 | −0.41 |
| Colorimetry b* | 1.49 | 1.45 | 1.18 |
| Colorimetry YI | 2.65 | 2.53 | 2.03 |
| Colorimetry ΔE | 1.9 | 2.17 | 2.23 |
| Test UV 12 hours (L*) | 90.04/89.89 | 90.33/90.06 | 90.22/90.18 |
| Test UV 12 hours (YI) | 2.65/4.52 | 2.53/3.71 | 2.03/4.69 |
| Test UV 12 hours (ΔE) | 1.90/1.44 | 2.17/1.67 | 2.23/1.73 |
| Gloss (85°) | 9.1 | 8.5 | 6.8 |
| Weight (g/m²) | 212 | 212 | 213 |
| Density (kg/m³) | 849 | 758 | 841 |
| Gurley porosity | 273 | 234 | 188 |
| (s/100 mL) | | | |
| Cobb test 1 min (3 | 24/25/25 | 31/32/33 | 25/25/26 |
| measurements) | | | |
| Dennison test | 9 | <8 | <8 |

The Cobb test is carried out according to standard ISO 535, the Dennison test is carried out according to standard TAPPI 459, the measurements of colour are carried out according to standard T527 OM94 (TAPPI), the colour system being expressed according to the CIE system L*, a*, b*.

It can be seen that the only significant effect on the coated paper from using the microporous material according to the invention is to increase its porosity.

### Example 3

### Manufacture of Plasterboard

The papers made on the pilot line were used for making plasterboards in the laboratory.

The properties of the boards prepared with the papers obtained in the pilot test are summarized in Table 4 below:

TABLE 4
various measurements on plasterboards with coated paper

| | Board with | Board with | Board with | |
|---|---|---|---|---|
| | pilot paper, | pilot paper, | pilot paper, | |
| | coating with | coating with | coating with | |
| | 0 wt % of | 0.75 wt % of | 2.25 wt % of | Reference |
| | microporous | microporous | microporous | factory- |
| | material | material | material | made board |
| Colorimetry L* | 90.19 | 90.36 | 90.1 | 89.0 |
| Colorimetry a* | −0.48 | −0.54 | −0.48 | −0.27 |
| Colorimetry b* | 1.78 | 1.9 | 1.53 | 1.78 |
| Colorimetry YI | 3.17 | 3.35 | 2.68 | 3.38 |
| Colorimetry ΔE | 1.89 | 2 | 1.93 | 0.40 |
| Gloss (85°) | 7.4 | 6.2 | 5.1 | 12.8 |
| Cobb test 1 | 10 | 11 | 18 | 6/6/6 |
| min | | | | |
| Adherence of a | 52 (rupture | 39 (rupture | 70 (rupture | 65 (rupture |
| jointing coating | in board | in board | in board | in board |
| (daN) | core) | core) | core) | core) |

It can be seen that the plasterboards manufactured with the papers whose coating contains microporous material have properties equivalent to those of a plasterboard prepared with a paper not containing gel of microporous material and are also equivalent to those of a reference factory-made board, also without microporous material.

### Example 4

### Paint

A paint is prepared from the following basic formulation:
water: 10.79%;
gel of Svenska Aerogel AB at 15% dry matter: 25%;
dispersant (Ecodis® P90, 40% dry matter): 0.44%;
antifoaming agent (Clerol® NXZ, 100% dry matter): 0.22%;
titanium dioxide (Tiona® 595): 10%;
calcium carbonate (Durcal® 5): 12.25%;
calcium carbonate (Mikhart® 15): 26%;
acrylic binder (Acronal® 5559, 50% dry matter): 15%;
thickener (Rheolate® 450, 30% dry matter): 0.30%.

The paint is applied by roller on a ceiling partition made from plasterboards. Observation of the surface after application reveals microcracks. The alpha w sound absorption after coating with paint is 0.45, whereas it was below 0.1 with a paint without gel of microporous material and 0.8 before coating.

The measurements were performed according to standard EN ISO 10534-2 (“Acoustics—Determination of sound absorption coefficient and impedance in impedance tubes—Transfer-function method”). Then the absorption coefficients were determined according to the calculation proposed by Albert Londin in “The determination of reverberant sound absorption coefficient from acoustic impedance measurements” (JASA Vol. 22, No. 2, March 1950). The single alpha w value was calculated with the absorption coefficients determined according to Londin's calculation and based on standard EN ISO 11654 (“acoustic sound absorber for use in building: rating of sound absorption”).

1. Plasterboard comprising a layer of plaster and at least one facing arranged on the latter, the facing being coated with a coating slip comprising a microporous material, said microporous material comprising agglomerates of precipitated silica.

2. Plasterboard according to claim 1, wherein the microporous material is present in an amount in a range from 0.1 to 10% in the coating slip, preferably in a range from 0.5 to 5%, and more preferably in a range from 2 to 4% of dry matter.

3. Plasterboard according to claim 1, wherein the coating slip is present on the facing in an amount in a range from 2 to 50 g/m², preferably in a range from 5 to 35 g/m², more preferably in a range from 10 to 20 g/m² of dry matter.

4. Plasterboard according to claim 1, wherein the silica agglomerates have a size Dv50 in a range from 0.5 to 500 μm, preferably in a range from 5 to 200 μm, and more preferably in a range from 10 to 200 μm.

5. Plasterboard according to claim 1, wherein the agglomerates of precipitated silica correspond to the formula MeOₓ.mSiO₂, in which Me represents at least two metals selected from Ca, Mg, Cu, Zn, Mn, Cd, Pb, Ni, Fe, Cr, Ag, Al, Ti, V, Co, Mo, Sn, Sb, Sr, Ba and/or W, x represents the molar ratio of oxygen to the metallic constituents, and m represents the molar ratio of SiO₂ relative to the metallic constituents, Me preferably representing Mg and Ca.

6. Plasterboard according to claim 5, wherein the molar ratio m is in a range from 1 to 4, preferably in a range from 2 to 3.5, more preferably in a range from 2.5 to 3.

7. Plasterboard according to claim 1, wherein the microporous material is obtainable by a method of manufacture comprising the following steps:
preparing a solution of at least two metal salts, in which the metal ions are divalent or polyvalent;
preparing a solution of alkali metal silicate;
mixing these solutions to form a coagulant;
rinsing and recovery of the coagulant;
optionally, adding impregnating agents to the coagulant.

8. Plasterboard according to claim 7, wherein, in the method of manufacture:
the solution of alkali metal silicate has a silicate/alkali metal molar ratio in a range from 1 to 4, preferably in a range from 2 to 3.7, more preferably in a range from 3 to 3.7 and even more preferably of about 3.35;
the alkali metal is K, Na or Li, preferably Na or K and more preferably Na; and/or
the metal salts are selected from the salts of Ca, Mg, Cu, Zn, Mn, Cd, Pb, Ni, Fe, Cr, Ag, Al, Ti, V, Co, Mo, Sn, Sb, Sr, Ba and/or W, preferably the salts of Ca and Mg; and/or
the metal salts are chlorides, acetates or nitrates, preferably magnesium chloride and calcium chloride; and/or
the solutions of metal salts have a concentration greater than or equal to 0.5 M, preferably greater than or equal to 1 M, more preferably greater than or equal to 1.5 M, and a concentration less than or equal to the saturation concentration; and/or
the solution of alkali metal silicate has a concentration of SiO₂ greater than or equal to 0.5 M, preferably greater than or equal to 1 M, more preferably greater than or equal to 1.4 M, ideally greater than or equal to 1.5 M, and preferably less than or equal to 4 M; and/or
the coagulant at the end of the rinsing and recovery step is adjusted to a dry matter content greater than or equal to 15%, preferably by filtration; and/or
rinsing of the coagulant comprises the removal of free anions present in the coagulant; and/or
the impregnating agents are selected from KMnO₄, C₂H₂O₄, C₆H₈O₇, Na₂S₂O₃, NaClO, KOH, NaOH, KI, NaI, K₂CO₃, Na₂CO₃, NaHCO₃ and/or KHCO₃, preferably KOH and/or KMnO₄; and/or
the impregnating agents are added to the coagulant in the form of crystalline powder, which is dissolved in the aqueous phase of the coagulant with stirring; and/or
the impregnating agents are present at a content in a range from 0 to 20%, preferably in a range from 5 to 20% and more preferably in a range from 10 to 20%, in the microporous material.

9. Plasterboard according to claim 1, wherein the coating slip further comprises plastic pigments, preferably in an amount in a range from 0.1 to 10%, more preferably in a range from 0.5 to 3% of dry matter.

10. Plasterboard according to claim 1, wherein the coating slip further comprises:
fillers, preferably comprising calcium carbonate and/or potassium carbonate, preferably in an amount in a range from 5 to 50%, more preferably in a range from 25 to 35% of dry matter; and/or
a binder, preferably comprising a synthetic latex and notably a styrene-butadiene resin, preferably in an amount in a range from 2 to 20%, more preferably in a range from 4 to 10% of dry matter; and/or
titanium dioxide, preferably in an amount in a range from 1 to 20%, more preferably in a range from 5 to 10% of dry matter; and/or
one or more additives selected from dispersants, antifoaming agents, thickeners, biocides and colorants.

11. Facing for plasterboard, the facing being coated with a coating slip comprising a microporous material, said microporous material comprising agglomerates of precipitated silica.

12. Facing according to claim 11, wherein the coating slip is a microporous material, said microporous material comprising agglomerates of precipitated silica, the microporous material is present in an amount in a range from 0.1 to 10% in the coating slip, preferably in a range from 0.5 to 5%, and more preferably in a range from 2 to 4% of dry matter.

13. Composition for coating plasterboard, comprising a microporous material, said microporous material comprising agglomerates of precipitated silica.

14. Composition according to claim 13, which is a coating slip for plasterboard facing and which is a microporous material, said microporous material comprising agglomerates of precipitated silica.

15. Composition according to claim 13, which is a paint for a wall made from plasterboards and in which preferably the microporous material includes agglomerates of precipitated silica wherein the silica agglomerates have a size Dv50 in a range from 0.5 to 500 μm, preferably in a range from 5 to 200 μm, and more preferably in a range from 10 to 200 μm.

16. Composition according to claim 15, comprising:
microporous material in an amount in a range from 0.2 to 15%, preferably in a range from 1.5 to 10%, and more preferably in a range from 5 to 7% of dry matter; and/or
fillers, preferably comprising calcium carbonate and/or potassium carbonate and/or titanium dioxide, preferably in an amount in a range from 20 to 95%, more preferably in a range from 70 to 90% of dry matter; and/or
a binder, preferably comprising an acrylic resin, preferably in an amount in a range from 2 to 20%, more preferably from 10 to 14% of dry matter; and/or
one or more additives selected from dispersants, antifoaming agents, thickeners, biocides and colorants.

17. Method of manufacturing a facing according to claim 11, comprising providing a facing paper, and applying the coating slip for plasterboard facing and which is a microporous material, said microporous material comprising agglomerates of precipitated silica, on the facing paper.

18. Method of manufacturing a plasterboard according to claim 1, comprising:
mixing a plaster paste for providing the layer of plaster of the plasterboard;
providing a first facing and a second facing;
applying the layer of plaster on the first facing;
applying the second facing on the layer of plaster applied;
forming, drying and optionally cutting into boards.

19. Method according to claim 18, wherein:
the first facing and/or the second facing is coated with a coating slip comprising a microporous material, said microporous material comprising agglomerates of precipitated silica; or
providing the first facing and/or the second facing comprises manufacturing the facing by providing a facing paper, and applying the coating slip for plasterboard facing and which is a microporous material, said microporous material comprising agglomerates of precipitated silica, on the facing paper; or
the coating slip for plasterboard facing and which is a microporous material, said microporous material comprising agglomerates of precipitated silica, is applied on the first facing and/or the second facing after applying the layer of plaster and before drying.

20. Use of a microporous material comprising agglomerates of precipitated silica, in order to increase the porosity of a plasterboard surface.

21. Use according to claim 20, wherein the microporous material includes agglomerates of precipitated silica wherein the silica agglomerates have a size Dv50 in a range from 0.5 to 500 μm, preferably in a range from 5 to 200 μm, and more preferably in a range from 10 to 200 μm.

22. Use according to claim 20, in order to increase the porosity of a plasterboard facing.

23. Use according to claim 20, wherein the microporous material is incorporated in the form of a gel in a coating slip for plasterboard facing or in a paint for a wall made from plasterboards, said gel preferably having a water content in a range from 40 to 95%, more preferably in a range from 60 to 92%, and even more preferably in a range from 80 to 90%.
